(19) United States
(12) Patent Application Publication
(10) Pub. No.: US 2012/0212433 A1
(43) Pub. Date: Aug. 23, 2012

(54) FLEXIBLE DISPLAY APPARATUS AND MOBILE TERMINAL USING THE SAME

(75) Inventors: Ju Sik LEE, Seoul (KR); Young Wook KIM, Seoul (KR); Chul Ho JANG, Bucheon-si (KR)

(73) Assignee: PANTECH CO., LTD., Seoul (KR)

(21) Appl. No.: 13/372,952

(22) Filed: Feb. 14, 2012

(30) Foreign Application Priority Data
Feb. 18, 2011 (KR) 10 2011-0014391

(51) Int. Cl. G06F 3/041

(52) U.S. Cl. 345/173

(57) ABSTRACT

A flexible display apparatus includes a flexible display unit including a front flexible surface to display an image and a rear flexible surface; a touch sensor unit to receive a touch input, the touch sensor unit disposed on the flexible display unit; and a guide unit to support the rear surface of the flexible display unit. A mobile terminal includes a flexible display apparatus including a flexible display unit and a guide unit, the guide unit supporting a rear surface of the flexible display unit; a support unit to support the flexible display apparatus to be unrolled in a first direction; and a body part to accommodate the support unit.

### CROSS-REFERENCE TO RELATED APPLICATION

This application claims priority from and the benefit of Korean Patent Application No. 10-2011-0014391, filed on Feb. 18, 2011, which is incorporated by reference for all purposes as if fully set forth herein.

### BACKGROUND

1. Field

The present disclosure relates to a flexible display apparatus and a mobile terminal using the same.

2. Discussion of the Background

The sizes of mobile communication terminals are becoming smaller and smaller, and a demand for a mobile communication terminal using a flexible display have been increased to selectively exploit a larger and wider display screen by utilizing the flexible property.

Since the flexible display may be gripped and accommodated in a folded or rolled state in a mobile communication terminal, it may be mounted into a mobile communication terminal to provide a large screen.

In an implementation of touch-input functions to a flexible display, conventional touch-implementing technologies have several limitations. Further, whereas the flexible display is bendable or flexible, flexible displays using indium tin oxide (ITO) may not be flexible enough to be used in a mobile communication terminal due to the flexibility limitation of ITO. Further, a stacked structure of a flexible display panel having a touch-input layer may not be flexible enough to be used in a mobile communication terminal. Accordingly, there is a demand for a flexible display providing touch-input functions and better flexibility for a mobile terminal. Additionally, since a rear surface of the stacked structure of the flexible display and the touch-input layer is not firmly supported, the flexible display may be insecurely gripped by a user, thereby causing erroneous touch inputs and resulting in malfunction.

### SUMMARY

Exemplary embodiments of the present invention provide a flexible display apparatus and a mobile terminal including the flexible display apparatus.

Additional features of the invention will be set forth in the description which follows, and in part will be apparent from the description, or may be learned by practice of the invention.

An exemplary embodiment of the present invention provides a flexible display apparatus, including a flexible display unit including a front flexible surface to display an image and a rear flexible surface; a touch sensor unit to receive a touch input, the touch sensor unit disposed on the flexible display unit; and a guide unit to support the rear surface of the flexible display unit.

An exemplary embodiment of the present invention provides a mobile terminal, including a flexible display apparatus including a flexible display unit and a guide unit, the guide unit to support a rear surface of the flexible display unit; a support unit comprising a first position and a second position, the support unit to support the flexible display apparatus to be unrolled in a first direction; and a body part to accommodate the support unit. The flexible display apparatus unrolls as the support unit moves from the first position to the second position.

An exemplary embodiment of the present invention provides a mobile terminal, including a flexible display apparatus including a flexible display unit to display an image, and a touch sensor unit to receive a touch input and to identify a touch point of the touch input; a support unit comprising a first position and a second position, the support unit to support the flexible display apparatus to be unrolled in a first direction; a body part to accommodate the support unit; and a controller to determine a portion of the flexible display unit to display the image. The flexible display apparatus unrolls as the support unit moves from the first position to the second position.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1A is a cross-sectional view of a flexible display apparatus according to an exemplary embodiment of the present invention.

FIG. 1B is an upper perspective view of the flexible display apparatus shown in FIG. 1A according to an exemplary embodiment of the present invention.

FIG. 1C is a lower perspective view of the flexible display apparatus shown in FIG. 1A according to an exemplary embodiment of the present invention.

FIG. 2 is a cross-sectional view of a flexible display apparatus according to an exemplary embodiment of the present invention.

FIG. 3 is a perspective view of a mobile terminal using a flexible display apparatus according to an exemplary embodiment of the present invention.

FIG. 4 is an enlarged perspective view of the ‘A’ portion in the flexible display apparatus shown in FIG. 3 according to an exemplary embodiment of the present invention.

FIG. 5 is a perspective view of a mobile terminal using a flexible display apparatus according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, XZZ, YZ, X).

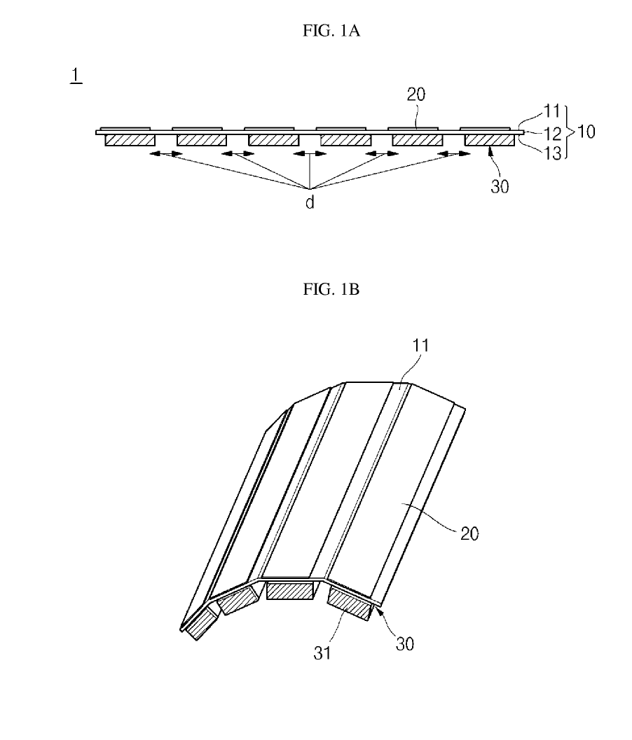

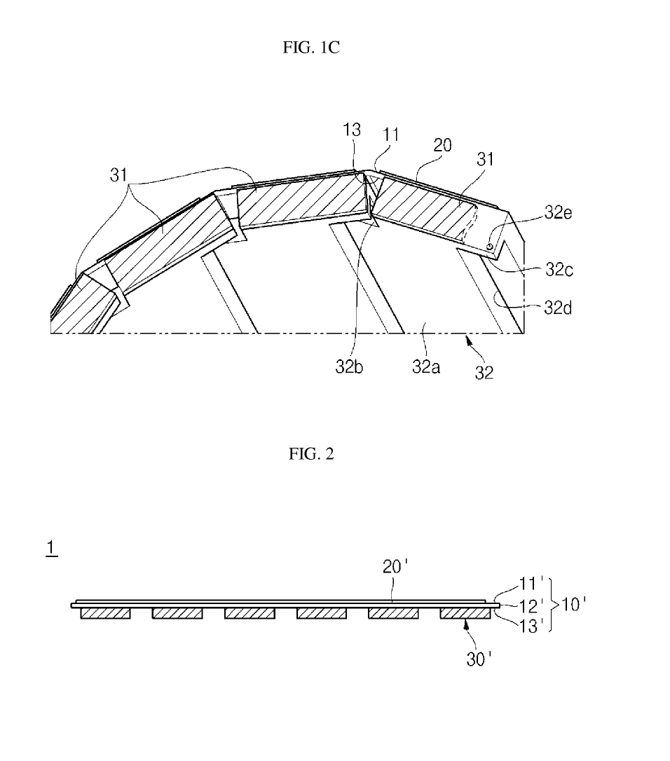

FIG. 1A is a cross-sectional view of a flexible display apparatus according to an exemplary embodiment of the present invention, FIG. 1B is an upper perspective view of the flexible display apparatus shown in FIG. 1A according to an exemplary embodiment of the present invention, and FIG. 1C is a lower perspective view of the flexible display apparatus shown in FIG. 1A according to an exemplary embodiment of the present invention. FIG. 2 is a cross-sectional view of a flexible display apparatus according to an exemplary embodiment of the present invention.

Referring to FIG. 1A, FIG. 1B, and FIG. 1C, the flexible display apparatus 1 includes a flexible display unit 10, touch sensors 20, and joint-type guide units 30. The flexible display unit 10 includes a front surface 11, an interior portion 12, and a rear surface 13.

The flexible display unit 10 may be a flexible sheet made of a plastic material and may be rolled due to the flexible nature of the flexible display unit 10.

An image may be displayed on the front surface 11 and touch sensors 20 may be provided on the top surface of the front surface 11. Specifically, touch sensors 20 may be disposed on corresponding regions of the front surface 11. Each touch sensor 20 may correspond to a support bar of the joint-type guide units 30. The touch sensors 20 may be a capacitive touch sensor designed as a flexible printed circuit (FPC), a resistive touch sensor, or a pressure-sensitive touch sensor. Further, although it is not shown, the touch sensors 20 may be integrated into the interior portion 12 of the flexible display unit 10. The data and power transmitted to the touch sensors 20 may be applied from a flexible printed circuit board (FPCB). The FPCB may be configured such that slots are formed uni-directionally and continuously in the central area of the FPCB. Further, as shown in FIG. 2, an FPCB having touch sensors 20′ may have rigid-flexible regions continuously formed without slots. For example, the FPCB may have multiple rigid portions alternatingly arranged with multiple flexible portions such that the FPCB may be rolled, bent, and stretched. The FPCB may be made of a transparent material.

The joint-type guide units 30 supporting the flexible display unit 10 may be arranged on the rear surface 13.

The joint-type guide units 30 may include support bars 32, which are disposed below the rear surface 13 so as to support the rear surface 13. The support bars 32, or facing surfaces thereof such as those measured between a body part 32a of a first support bar 32 and a coupling groove 32d of a second support bar 32, may be spaced apart by a distance (d). The joint-type guide units 30 may be configured such that the support bars 32 are sequentially connected to each other, as shown in FIG. 1C. Each of the support bars 32 may be linked to neighbor support bars 32. The links of the support bars 32 may be configured as hinge-type links, thereby enabling the support bars 32 to be rolled around a cylinder. The joint-type guide units 30 may guide the flexible display unit 10 to be rolled, and support the rear surface 13 while the flexible display unit 10 is unrolled. Further, support bars 32 of the joint-type guide units 30 may be spaced apart by the distance (d) from each other so as to reduce a risk of possible damages of the flexible display unit 10 while the flexible display unit 10 is rolled or in a rolled arrangement. Thus, in the flexible display apparatus 1, the flexible display unit 10 may be rolled such that the front surface 11 and the rear surface 13 do not directly contact with each other.

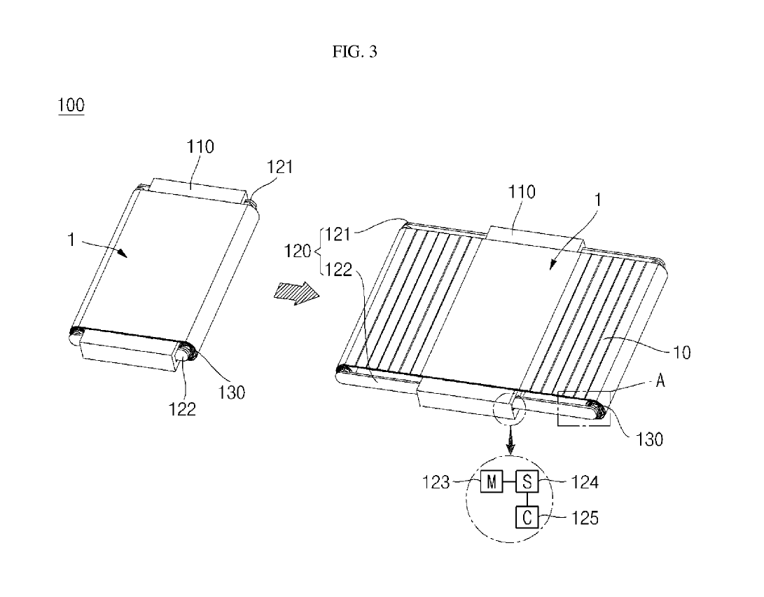

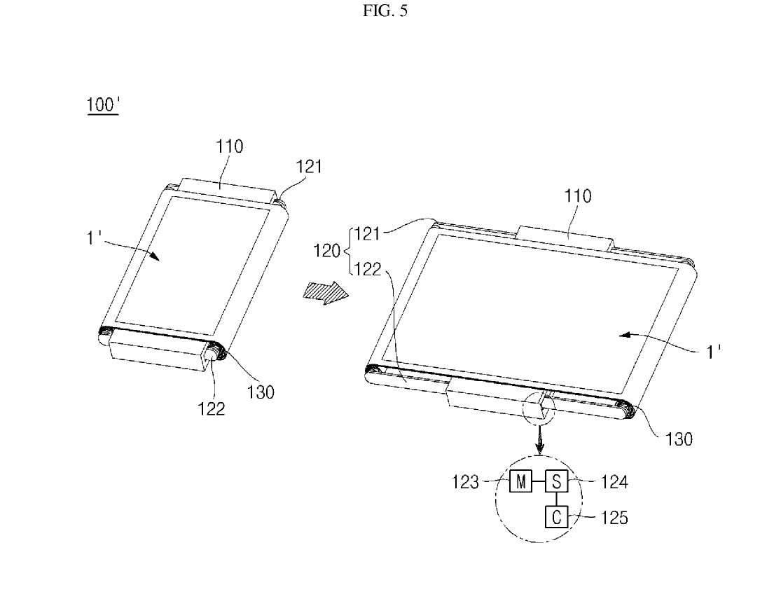

If the touch sensors 20 sense a touch input, the joint-type guide units 30 may determine a touch point represented by x-y coordinates using the pattern of the touch sensors 20 arranged on the front surface 11. A signal indicating the detected touch point, which may be referred to as a touch signal, may be transmitted to a control module (not shown). The control module may be a controller 125, shown in FIG. 3 and FIG. 5, which may be connected to the flexible display unit 10. Locations of the joint-type guide units 30 generating the touch signal may be detected by the control module, thereby detecting the touch point on the flexible display unit 10. For example, each support bar 32 of the joint-type guide units 30 may receive touch signal from the corresponding touch sensors 20 and transmit the touch signal to the controller 125. Further, each of the joint-type guide units 30 may include the corresponding pattern of the touch sensors 20. The touch signal indicates the touch point on the flexible display unit 10.

The joint-type guide units 30 may move along with an activated screen. The respective support bars 32 may also be activated or deactivated according to the size of the activated screen. In such a manner, the size of a touch sensing area may be variably adjusted. Thus, the joint-type guide units 30 may be actuated so as to turn the touch signal OFF to prevent the touch signal from being erroneously perceived, which may occur due to overlapping of touch inputs in a touch sensing area in a rolled state. Thus, a portion of the joint-type guide units 30 and a portion of the touch sensors 20 may be deactivated to turn off the touch signal recognition function while the portion of the joint-type guide units 30 and the portion of the touch sensors 20 are rolled. Further, the controller 125 may control an image to be displayed on the flexible display unit 10. Specifically, the resolution of the image, the size of the image, and display position of the image may be controlled by the controller 125.

Further, each of support bar 32 includes a body part 32a, a stepped part 32b, a protruding part 32c and a coupling groove 32d.

The stepped part 32b may be arranged at a first end in a lengthwise direction of the body part 32a. The stepped part 32b may be arranged such that the one end of the body part 32a is stepped with respect to planes of the opposite ends of the body part 32a. A second stepped part 32b (not shown) may be arranged at the second end of the body part 32a opposite to the first end. Although not shown, a fastening groove may be arranged on a bottom plane of the stepped part 32b to be coupled to the protruding part 32c of an adjacent support bar 32.

The protruding part 32c may be arranged at a second end opposite to the first end to be perpendicular to the lengthwise direction of the body part 32a. The protruding part 32c may be arranged to protrude to correspond to the second stepped part 32b to be coupled to the second stepped part 32 arranged in the adjacent support bar 32. Further, the protruding part 32c may include a fastening hole 32e and a protruded link may be inserted into fastening hole 32e to be coupled to the fastening groove of the stepped part 32b.

The coupling groove 32d arranged under the protruding part 32c in the lengthwise direction of the body part 32a. The coupling groove 32d may be shaped to correspond to the stepped part 32b to be engaged with a part protruding under the coupling groove 32d by the stepped part 32b. Thus, the support bar 32 and a support bar adjacent thereto may be rolled around the roll bar 130 (the cylinder) in such a manner that the stepped part 32b may be coupled to the protruding part 32c arranged in the adjacent support bar.

A shielded ground coating layer or a dielectric material layer 31 may be disposed at the opposite ends in the lengthwise direction of the body part 32a. Specifically, planes at opposite ends of the support bar 32 may be shielded by the ground coating layer or the dielectric material layer 31, thereby preventing or reducing the risk of noise signals or erroneous touch signals from being generated due to an unintended contact between a user's hand and the rear surface of the flexible display apparatus 1 while the user grips the flexible display apparatus 1. The ground coating layer or the dielectric material layer 31 may prevent an erroneous touch-input recognition if the user touches or grips the rear surface of the flexible display apparatus 1.

Unlike the conventional flexible display incorporating a touch input device in a stacked structure, the flexible display apparatus 1 may be rolled around the roll bar 130 while providing a touch-input function. Further, gripping and touch operations may be supported by using the joint-type guide units supporting the rear surface of the flexible display apparatus 1.

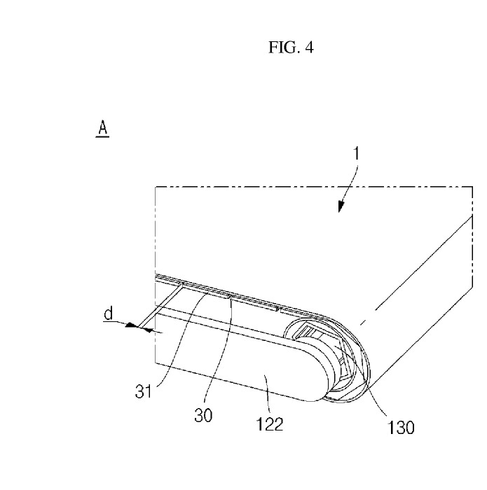

FIG. 3 is a perspective view of a mobile terminal using a flexible display apparatus according to an exemplary embodiment of the present invention. FIG. 4 is an enlarged perspective view of the ‘A’ portion in the flexible display apparatus shown in FIG. 3 according to an exemplary embodiment of the present invention. FIG. 5 is a perspective view of a mobile terminal using a flexible display apparatus according to an exemplary embodiment of the present invention.

As shown in FIG. 3 and FIG. 4, the mobile terminal 100 using a flexible display apparatus 1 includes a body part 110, a support unit 120, and a roll bar 130. The mobile terminal 100 may be a cellular phone, a personal communication system (PCS), a personal data assistant (PDA), a smart phone, a tablet computer, and so on. The flexible display apparatuses 1 and 1′ applied to the mobile terminal 100 shown in FIG. 3 and FIG. 4 may be substantially the same as the flexible display apparatus shown in FIG. 1A, FIG. 1B, FIG. 1C, and FIG. 2, thus repeated descriptions thereof will be omitted.

The body part 110 may be a body of the mobile terminal 100, and include a driving motor 123, a position sensor 124, and a controller 125 in addition to components for performing intrinsic operations of the mobile terminal 100, i.e., a communication function.

The driving motor 123 may be connected to the support unit 120 and drive an upper support unit 121 and a lower support unit 122 included in the support unit 120. The support unit 120 may slide to be expanded in opposite directions of the body part 110 as the driving motor 123 rotates. Further, the rotation amount of the driving motor 123 may be fed back to the controller 125, and allow the controller 125 to determine display area according to the rotation amount and to determine the size of the touch sensing area.

The position sensor 124 may sense movement information or the position information of the support unit 120. The position sensor 124 may sense a sliding location of the support unit 120 and transmit the sliding location to the controller 125 to allow the controller 125 to variably adjust the size of a display area and the range of a touch sensing area. As the support unit 120 slides, a portion of the touch sensors 20 and the flexible display unit 10 in the area rolled around the roller 130 may be turned off under the control of the controller 125, thereby variably adjusting the size of the display area and the range of the touch sensing area.

The controller 125 may adjust the size of the display area of the flexible display apparatus 1 based on the movement information of the support unit 120. Further, the controller 125 may detect the rotation amount of the driving motor 123 and may adjust the size of the display area based on the rotation amount and adjust the range of the touch sensing area of the touch sensors 20 based on the rotation amount.

The support unit 120 may be arranged to penetrate through top and bottom regions of the body part 110 of the mobile terminal 100 and is designed to be slidably unrolled in opposite directions of the body part 110, that is, left and right directions perpendicular to the lengthwise direction. Further, the support unit 120 may be arranged to penetrate through top and bottom regions of the body part 110 of the mobile terminal 100 and may be designed to be unrolled in one direction, that is, to be fixed in one direction of the body part 110 and to be unrolled (expanded) in the other direction of the body part 110 (e.g., expanded to the right and rolled-up to the left, or vice versa). The support unit 120 may be connected to the body part 110 of the mobile terminal 100 and may be designed to be slidably movable along the short-axis, perpendicular to the lengthwise direction, in the horizontal direction of the mobile terminal 100.

A separate button (not shown) may be arranged in the support unit 120 for the support unit 120 to be expanded according to the switching operation of the button. Further, the flexible display apparatus 1 may display a switch to expand the support unit 120, and the portion of the touch sensors 20 corresponding to the switch may be touched to control the support unit 120. Further, the support unit 120 may be expanded semi-automatically in a hinge manner.

The roll bar 130 may connect opposite ends of the upper supports unit 121 with opposite ends of the lower support unit 122. The flexible display apparatus 1 may be rolled around the outer circumferential surface of the roll bar 130. The roll bar 130 may be positioned left and right sides of the body part 110 of the mobile terminal 100 and may be a cylinder-type. The roll bar 130 may roll and accommodate the flexible display apparatus 1.

The joint-type guide units 30 may be arranged between the roll bar 130 and the mobile terminal 100, and the flexible display apparatus 1 may be guided to be rolled by the joint-type guide units 30. In addition, the joint-type guide units 30 may support a rear surface of the flexible display apparatus 1 when the flexible display apparatus 1 is unrolled.

Touch sensors 20 may be arranged on a front surface of the flexible display apparatus 1 rolled around the roll bar 130 to correspond to regions where the joint-type guide units 30 are disposed. The touch sensors 20 may also be provided within the flexible display apparatus 1. Further, as shown in FIG. 5, an FPCB implemented with the touch sensors may have alternative rigid and flexible regions continuously formed without slots. For example, the touch sensors may have touch-sensing portions and flexible linking portions. The touch-sensing portions and the flexible linking portions may be arranged alternatively.

In a rolling or unrolling operation, the mobile terminal 100 using the flexible display apparatus may allow a display mode to be smoothly changed based on the rotation amount of the driving motor 123. Further, shielded joint-type guide units may prevent or reduce the risk of the mobile terminal from malfunctioning. Further, since the rear surface of a flexible display unit is flexibly supported, a touch point may be more accurately detected.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A flexible display apparatus, comprising:
a flexible display unit comprising a front flexible surface to display an image and a rear flexible surface;
a touch sensor unit to receive a touch input, the touch sensor unit disposed on the flexible display unit; and
a guide unit to support the rear surface of the flexible display unit.

2. The flexible display apparatus of claim 1, wherein the guide unit comprises a first support bar and a second support bar connected to the first support bar, the second support bar to rotate with respect to the first support bar.

3. The flexible display apparatus of claim 2, wherein a first facing surface of the first support bar and a second facing surface of the second support bar are spaced apart from each other.

4. The flexible display apparatus of claim 2, wherein the first support bar comprises a stepped part to accommodate a protruding part of the second support bar.

5. The flexible display apparatus of claim 4, wherein the second support bar comprises a coupling groove adjacent to the protruding part, the coupling groove to receive a portion of the first support bar.

6. The flexible display apparatus of claim 4, wherein the protruding part of the second support bar comprises a fastening hole, the stepped part of the first support bar comprises a protruded link, and the fastening hole is rotatably connected to the protruded link.

7. The flexible display apparatus of claim 1, wherein the guide unit comprises a shielded layer.

8. The flexible display apparatus of claim 1, wherein the guide unit comprises support bars linked with each other, and the touch sensor unit comprises touch sensors arranged corresponding to the support bars, respectively.

9. The flexible display apparatus of claim 1, wherein the touch sensor unit comprises patternized touch-sensing portions and flexible linking portions alternatingly arranged.

10. A mobile terminal, comprising:
a flexible display apparatus comprising a flexible display unit and a guide unit, the guide unit to support a rear surface of the flexible display unit;
a support unit comprising a first position and a second position, the support unit to support the flexible display apparatus to be unrolled in a first direction; and
a body part to accommodate the support unit,
wherein the flexible display apparatus unrolls as the support unit moves from the first position to the second position.

11. The mobile terminal of claim 10, further comprising a controller to control an image to be displayed on the flexible display unit.

12. The mobile terminal of claim 11, wherein the controller determines a display area of the image, based on an unrolled state of the flexible display apparatus.

13. The mobile terminal of claim 10, wherein
the flexible display unit further comprises a touch sensor unit comprising a touch-sensing pattern, and
the controller determines a portion of the touch sensor unit to be deactivated, based on an unrolled state of the flexible display apparatus.

14. The mobile terminal of claim 10, further comprising a driving motor to move the support unit, and a switch to drive the driving motor.

15. The mobile terminal of claim 10, further comprising a roll-bar, around which a portion of the flexible display unit is rolled.

16. A mobile terminal, comprising:
a flexible display apparatus comprising a flexible display unit to display an image, and a touch sensor unit to receive a touch input and to identify a touch point of the touch input;
a support unit comprising a first position and a second position, the support unit to support the flexible display apparatus to be unrolled in a first direction;
a body part to accommodate the support unit; and
a controller to determine a portion of the flexible display unit to display the image,
wherein the flexible display apparatus unrolls as the support unit moves from the first position to the second position.

17. The mobile terminal of claim 16, further comprising a roll-bar, around which a portion of the flexible display unit is rolled.

18. The mobile terminal of claim 16, wherein the flexible display apparatus further comprises a guide unit to support a rear surface of the flexible display unit.

19. The mobile terminal of claim 16, wherein the guide unit comprises rotatably connected support bars, and the support bars respectively correspond to portions of the touch sensor unit.

20. The mobile terminal of claim 19, wherein a support bar receiving a touch signal of a corresponding portion of the touch sensor unit transmits the touch signal to the controller.
